(19) United States
(12) Patent Application Publication
(10) Pub. No.: US 2003/0034708 A1
(43) Pub. Date: Feb. 20, 2003

(54) Alternator rotor bobbin

(76) Inventors: Jeffrey Digby, Bowling Green, OH (US); Michael Timothy York, Chelsea, MI (US)

Correspondence Address: Thomas E. Donohue, Artz & Artz, P.C., Suite 250, 28333 Telegraph Road, Southfield, MI, 48034, US

(21) Appl. No.: 09/931,117

(22) Filed: Aug. 16, 2001

(51) Int. Cl. H02K 3/00; H02K 11/00

(52) U.S. Cl. 310/194; 310/71

(57) ABSTRACT

An alternator rotor bobbin 10 for use with a field coil wire 18 is provided, including a winding face 12 around which the field coil wire 18 is wound, a bottom face 16, a top face 14, a field coil entry port 24 positioned on the top face 14 to allow field coil wire 18 to enter the alternator rotor bobbin 10 in an axial direction while requiring only a single bend in the field coil wire 18, a field coil exit port 24 positioned on the top face 14 to allow the field coil exit wire 26 to exit the alternator rotor bobbin 10 in an axial direction, a field coil entry port tower 34, and a field coil exit port tower 36. The field coil entry port tower 34 and the field coil exit port tower 36 include a second snap element 37 to prevent the field coil wire 18 from coming unwound prior to assembly into an alternator rotor.

### TECHNICAL FIELD

The present invention relates generally to an alternator rotor bobbin and more particularly to an alternator rotor bobbin assembly with improved manufacturing, assembly, and performance characteristics.

### BACKGROUND OF THE INVENTION

Alternator rotors come in a variety of styles and configurations. One widely used style is the Lundell style alternator rotor. The Lundell style rotors are common in a variety of applications, including use on automotive vehicles. The standard Lundell rotor consists of two iron claw poles, a field coil wrapped on a plastic bobbin and a shaft extending through the pole bores.

Variations of the Lundell style rotors also exist. One variant of the standard Lundell design utilizes a recessed field coil to provide improvements over the conventional Lundell design. The recessed field coil Lundell rotor can allow a larger field, higher electrical output, and increased efficiency in comparison to the standard Lundell rotors. Both the standard Lundell as well as the recessed field coil Lundell rotor both utilize a field coil wrapped on a bobbin.

If the use of standard wire tie-offs on the field coil presents problems with standard Lundell rotors, it is even more emphasized when used in recessed field Lundell rotors. Often traditional field wire tie-off methods may not be utilized in recessed field coil designs since the outer diameter of the coil is close to the inner diameter of the annular ring in which the field is recessed. Therefore, a wire tie-off inside the outer diameter of the coil is often required. This allows the field coil to be as large as possible to provide improved electrical output power and increased efficiency.

In addition to the undesirable space requirements of traditional coil wire tie-offs, and the difficulty in utilizing them in recessed field coil designs, traditional wire tie-off methods can result in other undesirable characteristics. Often, the field coil plastic bobbin assembly must be carefully installed into the Lundell rotor in order to prevent electrical shorts. It is known manually sleeving the wires after the coil has been wound may reduce the incidents of electrical shorting. However, it does so at the expense of additional manufacturing time and costs. Finally, the mechanical forces exerted on the field coil wire are often greatest at the outer diameter of the coil. By positioning the wire tie-offs close to the outer diameter of the coil, the mechanical forces experienced by the field coil wire are undesirably increased.

It would, therefore, be highly desirable to have a field coil and rotor bobbin assembly with reduced size constraints, the flexibility to work with recessed field coil designs, with reduced electrical shorting and with reduced mechanical stresses on the field coil wire.

### SUMMARY OF THE INVENTION

It is, therefore, an object of the present invention to provide an alternator rotor bobbin with improved manufacturing and assembly properties, with design characteristics suitable for use in recessed field coils, with reduced mechanical forces transmitted to the field coil wire, and with improved shielding to prevent electrical shorts.

In accordance with the objects of the present invention, an alternator rotor bobbin is provided. The alternator rotor bobbin is intended for use with the field coil wire. The alternator rotor bobbin includes a winding face around which the field coil wire is wound. The alternator rotor bobbin further includes a bottom face and a top face. A field coil entry port is positioned on the top face and allows the field coil wire to enter the alternator rotor bobbin in an axial direction and requires only a single bend in the field coil wire to begin winding the field coil wire onto the winding face. A field coil exit port is positioned on the top face to allow the field coil wire to exit the alternator rotor bobbin in an axial direction. A field coil entry tower and a field coil exit tower both including snap fit elements prevent the field coil wire from becoming unwound.

Other objects and features of the present invention will become apparent when viewed in light of the detailed description of the preferred embodiment when taken in conjunction with the attached drawings and the appended claims.

### BRIEF DESCRIPTION OF THE DRAWINGS

FIG. 1 is an illustration of an embodiment of an alternator rotor bobbin in accordance with the present invention;

FIG. 2 is a detail of an embodiment of a field coil entry port for use on an alternator rotor bobbin in accordance with the present invention;

FIG. 3 is a detail of a field coil exit port for use on an alternator rotor bobbin in accordance with the present invention; and

FIG. 4 is an illustration of a recessed field coil Lundell-style rotor containing an embodiment of an alternator rotor and a bobbin in accordance with the present invention; and

FIG. 5 is a detail of a port tower containing a snap element in accordance with the present invention.

### DETAILED DESCRIPTION OF THE PREFERRED EMBODIMENT

Referring now to FIG. 1, which is an illustration of an alternator rotor bobbin 10 in accordance with the present invention. The alternator rotor bobbin 10 is intended for use in a recessed field coil Lundell-style alternator. It is contemplated, however, that the present invention may be used in conventional Lundell-style rotors as well as a variety of traditional alternator designs.

The alternator rotor bobbin 10 includes a winding face 12, top face 14, and a bottom face 16. The alternator rotor bobbin 10 is designed to have a field coil wire 18 wrapped around the winding face 12 of the alternator rotor bobbin 10. This is a common and well-known use of alternator rotor bobbins 10 and field coil wires 18. It should be understood that the field coil wire 18 is not shown wrapped around the winding face 12 in FIG. 1 only so that the winding face 12 may be seen. In an assembled alternator rotor bobbin 10 the field coil wire 18 may be wound around the winding face 12 until it approaches or slightly exceeds the bobbin outer diameter 20. Again, the winding of a field coil wire 18 around an alternator rotor bobbin 10 is well-known in the prior art.

The field coil entry port 22 and the field coil exit port 24 are positioned on the top face 14 Only a single bend in the field coil wire 18 is required to allow the field coil wire 18 to enter the alternator rotor bobbin 10 in an axial direction and begin wrapping around the winding face 12. By requiring only a single bend in order to enter the alternator rotor bobbin 10, the present invention reduces mechanical stresses on the field coil wire 18. It should be understood that all references to a single bend in the present application refer to sharp bending of the field coil wire 18 in a direction other than circumferential bending direction the field coil wire 18 bends to wrap around the winding face 12.

It is additionally preferable that the field coil entry port 22 and the field coil exit port 24 be positioned within the outer diameter 20 of the rotor bobbin 10. This further reduces mechanical loading on the field coil wire 18 as well as allowing the field coil wire 18 to be wound on the alternator rotor bobbin 10 all the way to or slightly beyond the outer diameter 20 of the alternator rotor bobbin 10. This last quality is one that is highly desirable in recessed field coil Lundell-style rotors.

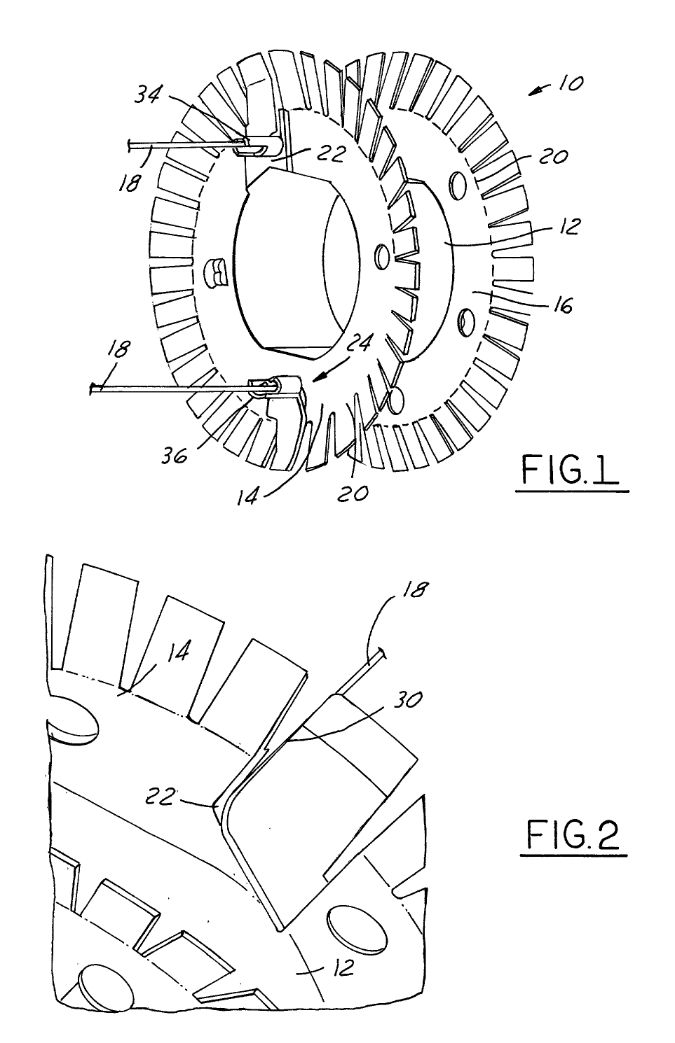

In addition to the advantages provided by having a field coil entry port 22 and a field coil exit port 24 positioned on the top face 14, additional improvements may be added to the alternator rotor bobbin 10 in order to further improve its functionality. One such improvement is illustrated in FIG. 2. The alternator rotor bobbin 10 may further include an entry slot 30 formed in the top face 14 of the alternator rotor bobbin 10. The entry slot 30 allows the field coil wire 18 to begin winding near the winding face 12 of the alternator rotor bobbin 10. It also allows the field coil entry port 22 to be placed close to the winding face 12 while still allowing for simplistic automated assembly. Although an entry slot 30 has been shown and described, it should be understood that the entry slot 30 need not be utilized to practice the present invention.

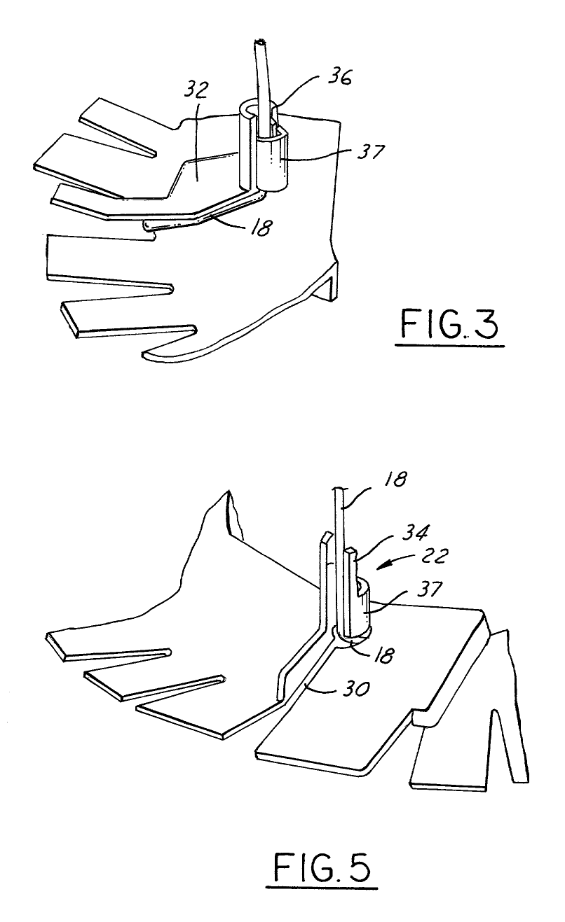

The present invention may further include an exit flange 32 as shown in FIG. 3. The exit flange 32 is simply a small flange formed on the top face 14 of the alternator rotor bobbin 10 to allow the field coil wire 18 to pass through the top face 14 to the field coil exit port 24. This allows the field coil wire 18 to be wound to the outer diameter 20 of the alternator rotor bobbin 10 and still able to reach field coil exit port 24 and exit the port in an axial direction. The exit flange 32 further serves to act as an insulator to prevent electrical shorting of the field coil wire 18 through contact with other parts of the alternator rotor. In an alternated embodiment, it is contemplated that the exit flange 32 may be replaced with a slot (not shown) similar in fashion to the entry slot 30.

The alternator rotor bobbin 10 may further include a field coil entry port tower 34 and a field coil exit port tower 36. These towers 34, 36 are found on the top face 14 of the alternator rotor bobbin 10. In one embodiment, the field coil entry port tower 34 and the field could exit port tower 36 are formed integrally with the alternator rotor bobbin 10. The towers 34, 36 serve a dual purpose. The towers 34, 36 provide a snap fit element 37 (see FIG. 5) that holds the field coil wire 18 in place to prevent it from coming unwound prior to assembly as well as serving as a guide to direct the field coil wire 18 through the field coil entry port 22 and field coil exit port 24. These unique snap fit elements 37 provide significant reductions in automated winding complexity and allow for a more efficient, reduced cost, and simplistic winding process. In one embodiment a flex slot 38 partially surrounds the field coil entry tower 34 allowing the field coil entry tower 34 to flex creating the snap fit element 37. Although a single example of a snap fit element 37 was illustrated, it should be understood that a wide variety of snap fit elements 37 are contemplated.

In addition, the towers 34, 36 provide protection from electrical shorts. The use of the towers 34, 36 can eliminate the necessity to manually sleeve field coil wire 18 prior to assembly into the alternator rotor as was sometimes necessary in the prior art. Thus a performance enhancement feature and a cost saving are accomplished simultaneously.

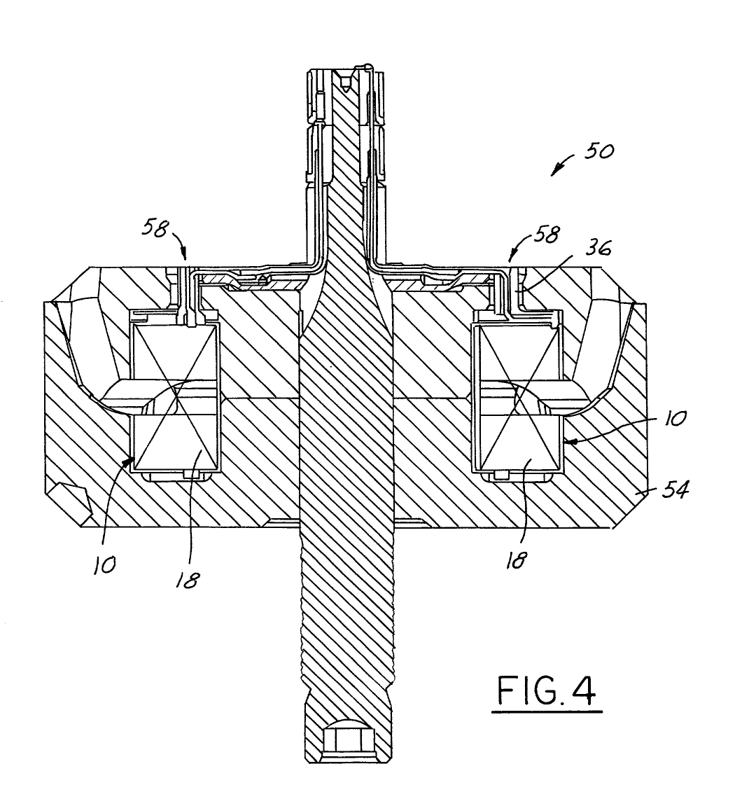

Referring now to FIG. 4, which is an illustration of a recessed field Lundell-style rotor 50 in accordance with the present invention. Although the alternator rotor bobbin 10 is illustrated installed in a recessed field Lundell-style alternator rotor 50, it should be understood that the alternator rotor bobbin 10 may be utilized in standard Lundell-style rotors as well as a wide variety of other styles of alternator rotors. The recessed field Lundell-style rotor 50 commonly consists of a stiffening annular iron pole piece 52, a secondary annual iron pole piece 54 and a shaft 56. The recessed field Lundell-style rotor 50 further includes the alternator rotor bobbin 10 with the field coil wire 18 wrapped around it. The towers 34, 36 on the alternator rotor bobbin 10, in addition to assisting in the winding of the field coil wire 18 on the alternator rotor bobbin 10, provide a guide for the field coil wire 18 through the pole ports 58 and the stiffening annular iron pole piece 52. The towers 34, 36 also provide protection from the stiffening annular iron pole piece 52 to prevent the field coil wire 18 from experiencing electrical shorts. The exit flange 32 also provides a shield against the stiffening annular iron pole piece 52 and thereby eliminates the necessity to manually sleeve the field coil wire 18 to prevent electrical connection with the stiffening annular iron pole piece 52. The position of the towers 34, 36 within the pole ports 58 provides support for the alternator rotor bobbin 10 and create a more robust alternator rotor design by supporting the alternator rotor bobbin 10 through contact with the pole ports 58.

The present invention provides a number of benefits over the prior art. By positioning the field coil entry port 22 and the field coil exit port 24 within the outer diameter 26 of the alternator rotor bobbin 10, the field coil wire 18 can be recessed allowing for a larger field and higher electrical output with increased efficiency. The necessity of manually sleeving the field coil wires 28 is further eliminated. The ability to use a stiffening annular iron pole piece 52 can improve high rpm capabilities of the alternator rotor. The mechanical forces on the field coil wire 28 has been reduced since the towers 34, 36 need to be posted closer to the axis of rotation. Finally, the position of the field coil exit and entry ports 22, 24 along with the support of the wire towers 34, 36 and ability to use a stiffening annular iron pole piece 52 creates an improved performance rotor with improved robustness.

While the invention has been described in connection with one or more embodiments, it is to be understood that the specific mechanisms and techniques which have been described are merely illustrative of the principles of the invention, numerous modifications may be made to the methods and apparatus described without departing from the spirit and scope of the invention as defined by the appended claims.

What is claimed is:

1. An alternator rotor bobbin for use with a field coil wire comprising:
a winding face around which the field coil wire is wound;
a bottom face;
a top face;
a field coil entry port positioned on said top face, said field coil entry port allowing the field coil wire to enter the alternator rotor bobbin in an axial direction and requiring only a single bend in the field coil wire to begin winding on said winding face; and
a field coil exit port positioned on said top face, said field coil exit port allowing the field coil wire to exit the alternator rotor bobbin in an axial direction;
a field coil entry port tower, said field coil entry port including a first snap element; and
a field coil exit port tower, said field coil exit port including a second snap element;
wherein said first snap element and said second snap element prevent the field coil wire from coming unwound prior to assembly into an alternator rotor.

2. An alternator rotor bobbin as described in claim 1 further comprising:
an entry slot formed in said top face creating a pathway from the edge of said top face to said field coil entry port tower.

3. An alternator rotor bobbin as described in claim 1 further comprising:
an entry slot formed in said top face creating a pathway from the edge of said top face to said field coil exit port tower.

4. An alternator rotor bobbin as described in claim 1 further comprising:
an exit flange.

5. An alternator rotor bobbin as described in claim 1 for use in a recessed field Lundell-style alternator rotor.

6. An alternator rotor bobbin as described in claim 1 wherein said field coil entry port is positioned within an outer diameter of said top face.

7. An alternator rotor bobbin as described in claim 1 wherein said field coil exit port is positioned within an outer diameter of said top face.

8. An alternator rotor bobbin as described in claim 1 wherein said field coil entry port tower is formed integrally with said top face.

9. An alternator rotor bobbin as described in claim 1 wherein said field coil exit port tower is formed integrally with said top face.

10. An alternator rotor bobbin as described in claim 1 further comprising:
a flex slot partially surrounding said field coil entry tower.

11. An alternator rotor bobbin for use with a field coil wire comprising:
a winding face around which the field coil wire is wound;
a bottom face;
a top face;
a field coil entry port positioned on said top face, said field coil entry port allowing the field coil wire to enter the alternator rotor bobbin in an axial direction and requiring only a single bend in the field coil wire to begin winding on said winding face; and
a field coil exit port positioned on said top face, said field coil exit port allowing the field coil wire to exit the alternator rotor bobbin in an axial direction;
a field coil entry port tower, said field coil entry port including a first snap element; and
a field coil exit port tower, said field coil exit port including a second snap element;
an entry slot formed in said top face creating a pathway from the edge of said top face to said field coil entry port tower; and
an exit flange;
wherein said first snap element and said second snap element prevent the field coil wire from coming unwound prior to assembly into an alternator rotor.

12. An alternator rotor bobbin as described in claim 11 for use in a recessed field Lundell-style alternator rotor.

13. An alternator rotor bobbin as described in claim 11 wherein said field coil entry port is positioned within an outer diameter of said top face.

14. An alternator rotor bobbin as described in claim 11 wherein said field coil exit port is positioned within an outer diameter of said top face.

15. An alternator rotor bobbin as described in claim 11 wherein said field coil entry port tower is formed integrally with said top face.

16. An alternator rotor bobbin as described in claim 11 wherein said field coil exit port tower is formed integrally with said top face.

17. An alternator rotor bobbin as described in claim 11 further comprising:
a flex slot partially surrounding said field coil entry tower.
